(19) United States
(12) Patent Application Publication
(10) Pub. No.: US 2023/0316424 A1
(43) Pub. Date: Oct. 5, 2023

(54) System and Method to Ensure Social Adhesion Between Selected Individuals and Groups of Individuals

(71) Applicant: James Albert Ionson, Lexington, MA (US)

(72) Inventor: James Albert Ionson, Lexington, MA (US)

(21) Appl. No.: 17/712,438

(22) Filed: Apr. 4, 2022

(51) Int. Cl. G06Q 50/00; G06F 16/906

(52) U.S. Cl. CPC G06Q 50/01; G06F 16/906

(57) ABSTRACT

The disclosed system and method for ensuring social adhesion between selected individuals and groups of individuals is based upon specific sensory driven social adhesion Psychological profiles as well as matching entertainment requirements; and which are designed to minimize and, in many cases, totally eliminate frustration and dissatisfaction. This invention utilizes sensory driven psychological profiles of select individuals and groups of individuals; and rule-based, machine learning artificial intelligence that correlates “customer” social adhesion profiles and preferred entertainment preferences with extensive databases describing in great detail available products and services.

### RELATED APPLICATIONS

This application claims the benefit of U.S. Provisional Application No. 63/170,340 filed Apr. 2, 2021, which is incorporated herein by reference in its entirety for all purposes.

The present application is related to U.S. Pat. No. 10,936,959, issued Mar. 2, 2021, for DETERMINING TRUSTWORTHINESS AND COMPATIBILITY OF A PERSON, by Sarabjit Singh Baveja, Anish Des Sarma, and Nilesh Dalvi, included by reference herein.

The present application is related to U.S. Pat. No. 10,868,789, issued Dec. 1, 2020, for SOCIAL MATCHING, by Arvind Mishra, Jonathan Eppers, Gregory Steiner and Joseph Essas, included by reference herein.

The present application is related to U.S. Pat. No. 10,545,326, issued Jan. 28, 2020, for PROVIDING TARGETED CONTENT BASED UPON USERS PREFERENCES, by Mark W. Publicover, William Knight Foster, included by reference herein.

The present application is related to U.S. Pat. No. 10,496,893, issued Dec. 3, 2019, for GENERATING PRODUCT DECISIONS, by Desai Paritosh, Kamal Gajendran, included by reference herein.

The present application is related to U.S. Pat. No. 10,475,056, issued Nov. 12, 2019, for SALES PREDICTION SYSTEMS AND METHODS, by Amanda Kahlow, included by reference herein.

The present application is related to U.S. Pat. No. 10,445,382, issued Oct. 15, 2019, for METHOD AND SYSTEM FOR RELATIONSHIP MANAGEMENT AND INTELLIGENT AGENT, by Geoffrey Hyatt, et. al., included by reference herein.

The present application is related to U.S. Pat. No. 10,411,908, issued Sep. 10, 2019, for INTERACTIVE ADVISORY SYSTEM, by Steven. A. Root, Michael R. Root, included by reference herein.

The present application is related to U.S. Pat. No. 10,410,243, issued Sep. 10, 2019, for AUTOMATIC RECOMMENDATION OF DIGITAL OFFERS TO AN OFFER PROVIDER BASED ON HISTORICAL TRANSACTION DATA, by Steven R. Boal, included by reference herein.

The present application is related to U.S. Pat. No. 10,395,275, issued Aug. 27, 2019, for SYSTEM AND METHOD FOR INTERACTIVE MARKETING, by Stephan Randall, et. al., included by reference herein.

The present application is related to U.S. Pat. No. 10,025,835, issued Jul. 17, 2018, for SELECTED MATCHES IN A SOCIAL DATING SYSTEM, by Clifford Lerner, included by reference herein.

The present application is related to U.S. Pat. No. 9,609,072, issued Mar. 28, 2017, for SOCIAL DATING, by Jennifer Jordan Louis and Paul Adams, included by reference herein.

The present application is related to U.S. Pat. No. 9,576,292, issued Feb. 21, 2017, for SYSTEMS AND METHODS TO FACILITATE SELLING OF PRODUCTS AND SERVICES, by Gregg Freishtat et. al., included by reference herein.

The present application is related to U.S. Pat. No. 8,171,032 B2, issued May 1, 2012, for PROVIDING CUSTOMIZED ELECTRONIC INFORMATION, by Frederick S. M. Herz, included by reference herein.

The present application is related to U.S. Pat. No. 8,131,012, issued Mar. 6, 2012, for BEHAVIORAL RECOGNITION SYSTEM, by Eaton, et al., included by reference herein.

The present application is related to U.S. Pat. No. 8,056,100 B2, issued Nov. 8, 2011, for SYSTEM AND METHOD FOR PROVIDING ACCESS TO DATA USING CUSTOMER PROFILES, by Frederick Herz, et. al., included by reference herein.

The present application is related to U.S. Pat. No. 8,001,067 B2, issued Aug. 16, 2011, for METHOD FOR SUBSTITUTING AN ELECTRONIC EMULATION OF THE HUMAN BRAIN INTO AN APPLICATION TO REPLACE A HUMAN, by Thomas A. Visel, Vijay Divar, Lukas K. Womack, Matthew Fettig, Hene P. Hamilton, included by reference herein.

The present a plication is related to U.S. Pat. No. 7,853,600 B2, issued Dec. 14, 2010, for SYSTEM AND METHOD FOR PROVIDING ACCESS TO VIDEO PROGRAMS AND OTHER DATA USING CUSTOMERS PROFILES, Frederick Herz, et. al., included by reference herein.

The present application is related to U.S. Pat. No. 7,483,871 B2, issued Jan. 27, 2009, for CUSTOMIZED ELECTRONIC NEWSPAPERS AND ADVERTISEMENTS, by Frederick S. M. Herz, included by reference herein.

The present application is related to U.S. Pat. No. 6,925,441 B1, issued Aug. 2, 2005, for SYSTEM AND METHOD OF TARGETED MARKETING, by Charles L. Jones, III, William A. Eginton, included by reference herein.

The present application is related to United Stated patent number 20180101866, issued Apr. 12, 2018, for SYSTEM AND METHOD FOR PREFERENCE DETERMINATION, by James Sawczuk, Jeffery French, included by reference herein.

The present application is related to United States patent number 20200051099, issued Feb. 13, 2020, for SALES PREDICTION SYSTEMS AND METHODS, by Amanda Kahlow, included by reference herein

The present application is related to United States patent number 20170061472, issued Mar. 2, 2017, for DYNAMIC MARKETING ASSET GENERATION BASED ON USER ATTRIBUTES AND ASSET FEATURES, Craig M. Mathis, included by reference herein.

The present application is related to United States patent number 20200005347, issued Jan. 2, 2020, for AUTOMATIC RECOMMENDATION OF DIGITAL OFFERS TO AN OFFER PROVIDER BASED UPON HISTORICAL TRANSACTION DATA, by Steven R. Boal, included by reference herein.

The present application is related to United States patent number 20160034588, issued Feb. 2, 2016, for METHOD AND SYSTEM FOR RELATIONSHIP MANAGEMENT AND INTELLIGENT AGENT, by Geoffrey Hyatt, included by reference herein.

Other Publications:

John E. Lard and Shiwali Mohan, “A Case Study of Knowledge Integration across Multiple Memories in SOAR”, Biologically Inspired Cgnitive Architectures, April 2014, 8, pp. 93-99.

Victor C. Hung and Avelino J. Gonzalez, “Towards a Human Behavior Model Based on Instincts”, Proceedings of BRIMS, 2007.

Canamero, “Modeling Motivations and Emotions as a Basis for Intelligent Behavior”, Prd. First Int. Symp. on Autonomous Agents, AA, The ACM Press, 1997.

A. R. Damasio, “Descartes' Error: Emotion, Reason and the Human rain Robot”, New York, USA: Picador, 1994.

Eugene Eberbach, “Expressing Evolutionary Computation, Genetic Programming, Artificial Life, Autonomous Agents and DNA-Based Computing in $-Calculus—Revised Version”, August 2013.

Eugene Eberbach, “$-Calculus of Bounded Rational Agents: Flexible Optimization as Search under Bounded Resources in Interactive Systems”, FundamentaInformaticae 68, 47-102, 2005

Eugene Eberbach, “$-Calculus Bounded Rationality=Process Algebra+Anytime Algorithms”, Applicable Mathematics: Its Perspectives and Challenges, Narosa Publishing House, New Delhi, Mumbai, Calcutta, 532-539, 2001.

Euvgen Eberbach and Shashi Phoha, “SAMON: Communication, Cooperation and Learning of Mobile Autonomous Robotic Agents, Proc. of the 11th IEEE. Conf. on Tools with Artificial Intelligence ICTAI '99, Chicago, IL, 229-236, 1999.

Goerke, “EMOBOT: A Robot Control Architecture Based on Emotion: Internal Values”, Mobile Robots, Moving Intelligence (ed J. Buchli). ARS/pIV, Germany, 75-94, 2006.

J. D. Velasguez, “When Robots Weep: Emotional Memories and Decision-Making”, Proc. 15th National Conference on Artificial intelligence, AAAI Press, Madison, Wisconsin, USA, 1997.

M. Salichs and M. Makfaz, “Using Emotions on Autonomous Agents. The Role of Happiness, Sadness and Fear.”, Adaptation in Artificial and Biological Systems (AISB '06), Bristol, England, 157-164, 2006.

John E. Laird, “The SOAR Cognitive Architecture”, MIT Press, May 2012.

Robert P. Marinier III and John F. Laird, “Emotion-Driven Reinforcement Learning”, http://sitemaker.umich.edu/marinier/files/marinier_laird_cogsci_2008_emotionrl.pdf

Ivaylo Popov and Krasimir Popov, “Adaptive Cognitive Method”, USPTO Publication #20140025612, January 2014.

Leonid T. Perlovsky, “Modeling Field Theory of Higher Cognitive Functions”, Chapter III in “Artificial Cognition Systems, Eds. A. Loula, R. Gudwin, J. Queiroz. Idea Group, Hershey, PA, pp. 64-105, 2006.

Leonid I. Perlovsky and R. Kozma., Eds., “Neurodynamics of Higher-Level Cognition and Consciousness”, ISBN 978-3-540-73266-2, Springer-Verlag, Heidelberg, Germany, 2007.

Leonid I. Perlovsky, “Sapience, Consciousness, and the Knowledge Instinct. (Prolegomena to a Physical Theory)”, In Sapient Systems, Eds. Mayorga, R, Perlovsky, L. I., Springer, London, 2007.

Patrick Soon-Shiong, “Reasoning Engines” USPTO Publication #420140129504, May 2014.

Nikolaos Anastasopoulos, “Systems and Methods for Artificial Intelligence Decision Making in a Virtual Environment”, USPTO Publication #20140279800, September 2014.

Jitesh Dundas and David Chik, “Implementing Human-Like Intuition Mechanism in Artificial Intelligence”, http://www.arxiv.org/abs/1106.5917, Jun. 29, 2011.

Carlos Gershenson, “Behaviour-based Knowledge Systems: An igenetic Path from Behaviour to Knowledge”, http://cogprints.org/220/3/Gershenson-BBKS-Epigenetics.pdf.

Michael D. Byrne, “Cognitive Architectures in HCI: Present Work and Future Directions”, http://chil.rice.edu/research/pdf/Byrne_05.pd.f

### FIELD OF THE INVENTION

The present invention relates generally to machine behavior, and more specifically to highly personalized social adhesion matching based upon sensory driven psychological profiling of selected individuals and group social behaviors; and the utilization of rule-based, machine learning artificial intelligence to correlate “social adhesion profiles and associated individual and group entertainment venues with extensive available databases describing in great detail available products and services.

### BACKGROUND OF THE INVENTION

The proliferation of social media platforms has resulted in numerous opportunities for selected individuals and groups of individuals to explore mutual interests and desires to engage in social media events with the hope of optimizing social adhesion between select individuals and groups of individuals. There has also been a proliferation of leisure and entertainment venues making it increasingly difficult for individuals and groups to align on venue choices that optimize the personal likes and dislikes of these individuals and groups which often are an integration of many diverse cultures, backgrounds and experiences. The providers of these social matching services and associate leisure and entertainment venues make attempts to target their customers with personalized recommendations which are biased towards the merchant and not the customer. This bias often leads to recommendations which do not fill the social adhesion requirements of the customer resulting in frustration and disappointment for both the merchant as well as the customer. Essential all of these “targeted Marketing” approaches are based only upon historical buying patterns and search patterns of customers which represent only a limited “like and dislike” profile of targeted customers. There have been recent attempts to incorporate these limited, targeting marketing approaches into algorithmic and digital applications that are usually deployed as mobile and/or desktop computer/Internet applications but the core deficiency related to an incomplete and quite unsophisticated customer profile remains. A few of these systems, methods and application are disclosed in in U.S. Pat. No. 10,936,939, “DETERMINING TRUSTWORTHINESS AND COMPATIBILITY OF A PERSON”, U.S. Pat. No. 10,868,789, “SOCIAL MATCHING”, U.S. Pat. No. 10,025,835, “SELECTED MATCHES IN A SOCIAL DATING SYSTEM”, U.S. Pat. No. 9,609,072, “SOCIAL DATING”, U.S. Pat. No. 6,925,441 B1, “SYSTEM AND METHOD OF TARGETED MARKETING”, U.S. Pat. No. 9,576,292, “SYSTEMS AND METHODS TO FACILITATE SELLING OF PRODUCTS AND SERVICES”, U.S. Pat. No. 8,056,100 B2, “SYSTEM AND METHOD FOR PROVIDING ACCESS TO DATA USING CUSTOMER PROFILES”, USPTO Publication #20200051099, “SALES PREDICTION SYSTEMS AND METHODS”, and USPTO Publication #20200005347, “AUTOMATIC RECOMMENDATION OF DIGITAL OFFERS TO AN OFFER PROVIDER BASED UPON HISTORICAL TRANSACTION DATA”, all incorporated herein by reference in their entirety. Although these disclosures describe semi-automated matching services and products to customers, they are based upon generic profiling of the customers without sufficient granularity to properly ensure social adhesion coupled with effective entertainment venues. Although the customer is offered so-called “perfect matches”, these recommendations are not truly personalized and are biased towards what the merchant wants to sell rather than what the customer actually wants to buy. This deficiency drives customer dissatisfaction and frustration which is not in the best interest of both the merchant and the customer. Therefore, there is a need for a process and method that ensures social adhesion between selected individuals and groups of individuals based upon correlating the sensory driven physiological social Adhesion profiles of the customer with the vast spectrum of services and products offered by merchants. Key to this system and method is the process used to create a wide variety of highly Personalized metrics associated with sensory driven psychological profiles of the customer along with a highly advanced rule-based artificial intelligence engine that correlates these profiles and desires with available products and services. Also needed is a highly secure communications systems that protects the customer from third parties that could use these profiles for other nefarious purposes.

### SUMMARY OF THE INVENTION

The following presents a simplified summary of the invention an order to provide a basic understanding of some aspects of the invention. This summary is not an extensive overview of the invention. It is intended to neither identify key or critical elements Of the invention nor delineate the scope of the invention. Its sole purpose is to present some concepts of the invention in a simplified form as a prelude to the more detailed description that is presented later.

In accordance with the present invention, there is provided a system and method to ensure social adhesion between selected individuals and groups of individuals highly targeted and specific to sensory driven social adhesion Psychological profiles as well as customer entertainment requirements; and which are designed to minimize and in many cases totally eliminate frustration and dissatisfaction. This invention utilizes sensory driven psychological profiles of select individuals and groups of individuals; and rule-based, machine learning artificial intelligence that correlates “customer” social adhesion profiles and preferred entertainment preferences with extensive databases describing in great detail available products and services. The invention comprises a software, firmware, hardware and combinations thereof user's social adhesion database that reflects the psychological traits driving social adhesion including but not limited to likes, dislikes, social compromises within groups as well as group interactive behavior patterns and trends; a software, firmware, hardware and combinations thereof leisure and entertainment database for Providing detailed characteristics of products and services ln a manner that can be correlated with the psychological social adhesion traits of select individuals and groups of individuals; a software, firmware, hardware and combinations thereof user's request for social adhesion match including social event recommendations for enabling a user to describe the kind of product and or service desired without specifying where, and how this product and or service can be acquired; a software, firmware, hardware and combinations thereof rule-based artificial intelligence recommendation engine, for correlating a user's social adhesion traits with requests for leisure and entertainment venues through the utilization of rule-based correlation techniques such as, but not limited to case-based reasoning, fuzzy models, inference engine and semantic reasoning approaches; a software, firmware, hardware and combinations thereof data mining tools, for targeting data that can be correlated with users psychological profiles, available leisure and entertainment products and services and user requests for asocial event recommendations through the utilization of techniques such as, but not limited to tracking patterns, Classification, association, outlier detection and clustering; and a software, firmware, hardware and combinations thereof secure interactive communications module, for enabling highly secure communication interactions such as, but not limited to audiovisual and text data streams between, but limited to, multiple users and participants over communications networks such as, but not limited to, Internet, cellular, and internal hardwired and/or wireless networks. This system and method provides a very robust and simple way to ensure social adhesion between select individuals and group combined with leisure and entertainment recommendations that are specifically tailored to their desires.

### BRIEF DESCRIPTION OF THE DRAWINGS

A complete understanding of the present invention may be obtained by reference to the accompanying drawings, when considered in conjunction with the subsequent, detailed description, in which:

FIG. 1 illustrates the differences between typical generic customer profiling and more comprehensive psychological profiling disclosed in this invention note that although both approaches utilize conventional rule-based artificial intelligence, this invention's psychological profiling approach is far more granular and comprehensive necessitating the utilization of more advanced rule-based systems such as, but not limited to, case-based reasoning, rule-based systems, artificial neural networks, fuzzy models, genetic algorithms, cellular automata, multi-agent systems, swarm intelligence, reinforcement learning and hybrid systems and

FIG. 2 illustrates the fundamental functionality of the disclosed system and method as wall as now those functions reflate to one another.

For purposes of clarity and brevity, like elements and components will bear the same designations and numbering throughout the Figures.

### DESCRIPTION OF THE PREFERRED EMBODIMENT

To provide an overall understanding certain illustrative embodiments will be described; however, it will be understood by one skilled in the art of psychological profiling, data collection and analysis, communication protocols and rule-based artificial intelligence that the system and method described can be adapted and modified to provide other suitable applications and that additions and modifications can be made without departing from the scope of the system and method described herein.

The problem being addressed relates to matching several individual entities or couples in a group and make that heterogeneous group highly compatible for each of the participants. In a group the first thing is to distinguish potential discomfort and to eliminate social frictions as a first step. This means not putting an element into the group which can perturb the group or another element of the group which essentially minimizes social friction with the group. Social adhesion within groups it not always about similar interests which of course is an influencing parameter. Effective social adhesion is based upon the sense of sight, touch, hearing, tasting, and smell, all of which have collected raw data over years of a person's lifetime. The human brain processes this data into conscious and subconscious information that drives individual likes and dislikes. In essence our five senses collect data over years of experiences and builds a framework of an individual's social preferences which are integral to ensuring social adhesion between individuals and group of individuals. Effective social adhesion also requires a granular matching of available leisure and entertainment events and venues which match the social adhesion framework uniquely defined by select individuals and groups of individuals comprising the social group.

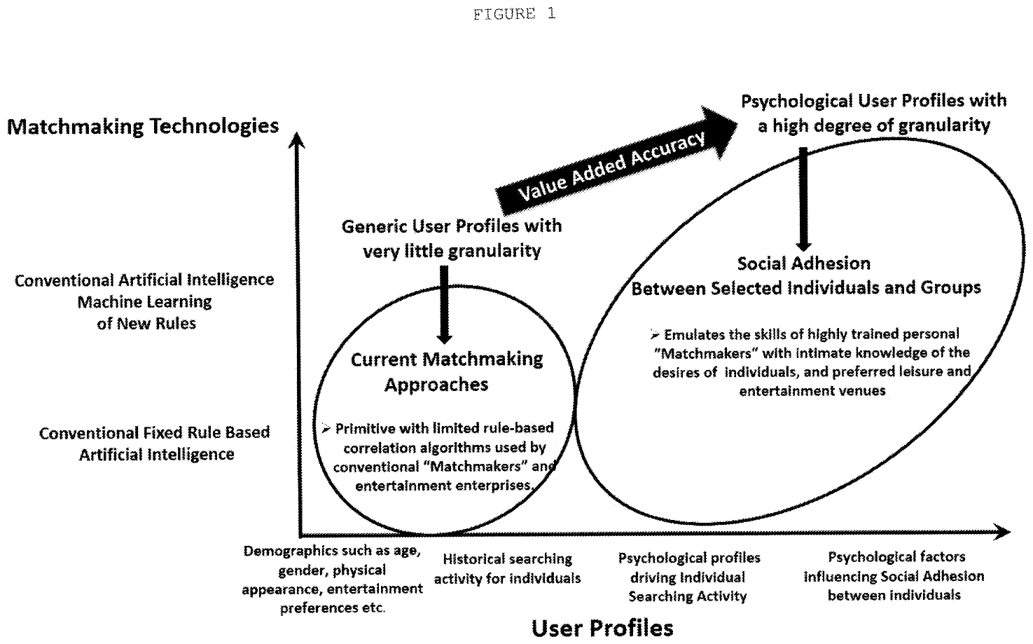

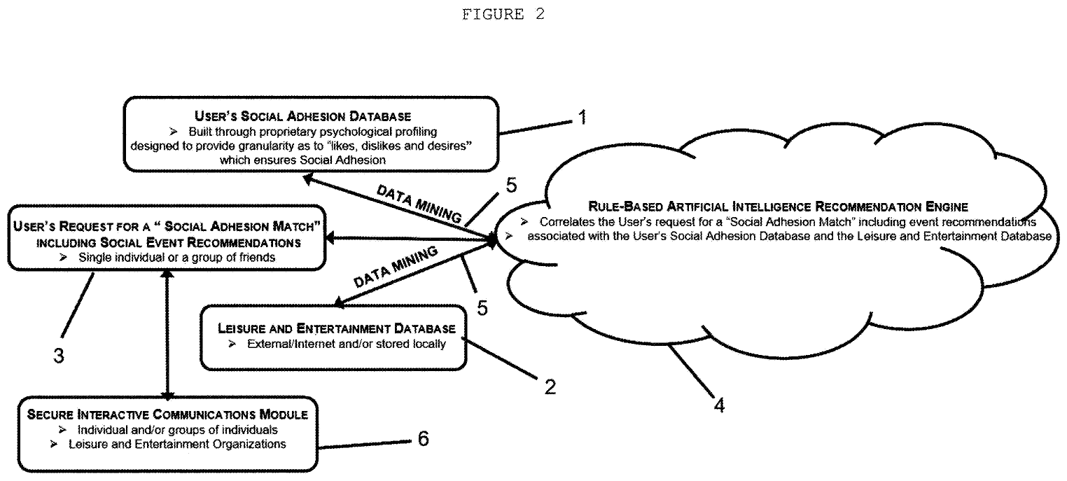

FIG. 1 illustrates the differences between typical generic customer profiling and more comprehensive psychological profiling disclosed in this invention. Note that although both approaches utilize conventional rule-based artificial intelligence, this invention's psychological profiling approach is far more granular and comprehensive necessitating the utilization of more advanced rule-based systems such as, but not limited, to, case-based reasoning, rule-based systems, artificial neural networks, fuzzy models, genetic algorithms, cellular automata, multi-agent systems, swarm intelligence, reinforcement learning and hybrid systems. Also, in accordance with the present invention, there is provided a psychology driven system and method (FIG. 2) for providing personalized and group buying recommendations that are highly targeted and specific to the buying requirements of a customer; and which are designed to minimize and an many cases totally eliminate frustration and dissatisfaction. This invention utilizes enhanced psychological profiling of individual and group social behaviors and rule-based, machine learning artificial intelligence that correlates “customer” social adhesion profiles and preferred entertainment preferences with extensive publicly available online databases describing in great detail available products and services. The invention comprises a software, firmware, hardware and combinations thereof user's social adhesion database 1, for creating a highly personalized database that reflects the psychological traits driving social behavior patterns including but not limited to likes, dislikes, social compromises within groups as well as group interactive behavior patterns and trends; a software, firmware, hardware and combinations thereof leisure and entertainment database 2, for providing a database which details characteristics of products and services in a manner that can be correlated with the psychological buying behaviors of individual and social groups of individuals; a software, firmware, hardware and combinations thereof user's request for social adhesion match including social event recommendations 3, for enabling a user to describe the kind of product and or service desired without specifying where, and how this product and or service can be acquired; a software, firmware, hardware and combinations thereof rule-based artificial intelligence recommendation engine 4, for correlating a user's psychological buying behaviors and requests for buying recommendations with available products and services utilizing rule-based correlation techniques such as, but no limited to case-based reasoning, fuzzy models, inference engine and semantic reasoner approaches; a software, firmware, hardware and combinations thereof data mining technologies 5, for targeting data that can be correlated with users psychological buying profiles, available products and services and user requests for a buying recommendations; utilizing techniques such as, but not limited to tracking patterns, classification, association, outlier detection and clustering; and a software, firmware, hardware and combination s thereof secure interactive communications module 6, for enabling highly secure communication interactions such as, but not limited to audiovisual and text data streams between, but limited to, multiple users and participants over communications networks such as, but not limited to, Internet, cellular, and internal hardwired and/or wireless networks. This system and method provides a very robust and simple way to ensure social adhesion between select individuals and group combined with leisure and entertainment recommendations that are specifically tailored to their desires.

Since other modifications and changes varied to fit particular operating requirements and environments will be apparent to those skilled in the art, the invention is not Considered limited to the example chosen for purposes of disclosure and covers all changes and modifications which do not constitute departures from the true spirit and scope of this invention.

Having thus described the invention, what is desired to be protected by Letters Patent is presented in the subsequently appended claims:

1. A system and method to ensure social adhesion between selected individuals and groups of individuals for enabling an optimized matching process and method based upon sensory driven psychological profiling of selected individuals and groups through the utilization of rule-based, machine learning artificial intelligence to correlate “social profiles” and preferred entertainment venues with extensive available databases, comprising:
means for creating a highly personalized database that comprises sensory driven psychological traits which define social adhesion including but not limited to likes, dislikes, social compromises within groups as well as group interactive behavior patterns and trends;
means for providing a database which details characteristics of leisure and entertainment products and services in a manner that can be correlated with the psychological social adhesion profiles behaviors of selected individual and groups of individuals;
means for enabling a user to describe a social adhesion event without specifying where and how this product and or service can be acquired;
means for correlating a user's psychological social adhesion profile and requests for social adhesion event recommendations with available products and services utilizing rule-based correlation techniques such as, but not limited to case-based reasoning, fuzzy models, inference engine and semantic reasoner approaches;
means for targeting data that can be correlated with user's social adhesion profiles, available leisure and entertainment products and services and user requests for social adhesion event recommendations; utilizing techniques such as, but not limited to tracking patterns, classification, association, outlier detection and clustering; and
means for enabling highly secure Communication interactions such as, but not limited to audiovisual and text data streams between, but not limited to, multiple users and participants over communications networks such as, but not limited to, internet, and internal hardwired and/or wireless networks.

2. The system and method to ensure social adhesion between selected individuals and groups of individuals in accordance with claim 1, wherein said means for creating a highly personalized database that comprises sensory driven psychological traits which define social adhesion including but not limited to likes, dislikes, social compromises within groups as well as group interactive behavior patterns and trends comprises a software, firmware, hardware and combinations thereof user's social adhesion database.

3. The system and method to ensure social adhesion between selected individuals and groups of individuals in accordance with claim 1, wherein said means for providing a database which details characteristics of leisure and entertainment products and services in a manner that can be correlated with the psychological social adhesion profiles behaviors of selected individual and groups of individuals comprises a software, firmware, hardware and combinations thereof leisure and entertainment database.

4. The system and method to ensure social adhesion between selected individuals and groups of individuals in accordance with claim 1, wherein said means for enabling a user to describe a social adhesion event without specifying where and how this product and or service can be acquired comprises a software, firmware, hardware and combinations thereof user's request for social adhesion match including social event recommendations.

5. The system and method to ensure social adhesion between selected individuals and groups of individuals in accordance with claim 1, wherein said means for correlating a user's psychological social adhesion profile and requests for social adhesion event recommendations with available products and services utilizing rule-based correlation techniques such as, but not limited to case-based reasoning, fuzzy models, inference engine and semantic reasoner approaches comprises a software, firmware, hardware and combinations thereof rule-based artificial intelligence recommendation engine.

6. The system and method to ensure social adhesion between selected individuals and croups of individual accordance with claim 1, wherein said means for targeting data that can be correlated with user's social adhesion profiles, available leisure and entertainment products and services and user requests for social adhesion event recommendations; utilizing techniques such as, but not limited to tracking patterns, classification, association, outlier detection and clustering comprises a software, firmware, hardware and combinations thereof data mining technologies.

7. The system and method to ensure social adhesion between selected individuals and groups of individuals in accordance with claim 1, wherein said means for enabling highly secure communication interactions such as, but not limited to audiovisual and text data streams between, but not limited to, multiple users and participants over communications networks such as, but not limited to, internet, cellular, and internal hardwired and/or wireless networks comprises a software, firmware, hardware and combinations thereof secure interactive communications module.

8. A system and method to ensure social adhesion between selected individuals and groups of individual for enabling an optimized matching process and method based upon sensory driven psychological profiling of selected individuals and groups through the utilization of rule-based, machine learning artificial intelligence to correlate “social profiles” and preferred entertainment venues with extensive available databases, comprising:
a software, firmware, hardware and combinations thereof user's social adhesion database, for creating a highly personalized database that comprises sensory driven psychological traits which define social adhesion including but not limited to likes, dislikes, social compromises within groups as well as group interactive behavior patterns and trends;
a software, firmware, hardware and combinations thereof leisure and entertainment database, for providing a database which details characteristics of leisure and entertainment products and services in a manner that can be correlated with the psychological social adhesion profiles behaviors of selected individual and groups of individuals;
a software, firmware, hardware and combinations thereof user's request for social adhesion match including social event recommendations, for enabling a user to describe a social adhesion event without specifying where and how this product and or service can be acquired;
a software, firmware, hardware and combinations thereof rule-based artificial intelligence recommendation engine, for correlating a user's psychological social adhesion profile and requests for social adhesion event recommendations with available products and services utilizing rule-based correlation techniques such as, but not limited to case-based reasoning, fuzzy models, inference engine and semantic reasoner approaches;
a software, firmware, hardware and combinations thereof data mining technologies, for targeting data that can be correlated with user's social adhesion profiles, available leisure and entertainment products and services and user requests for social adhesion event recommendations; utilizing techniques such as, but not limited to tracking patterns, classification, association, outlier detection and clustering; and
a software, firmware, hardware and combinations thereof secure interactive communications module, for enabling highly secure communication interactions such as, but not limited to audiovisual and test data streams between, but not limited to, multiple users and participants over communications networks such as, but not limited to, internet, cellular, and internal hardwired and/or wireless networks.

9. A system and method to ensure social adhesion between selected individuals and groups of individuals for enabling an optimized matching process and method based upon sensory driven psychological profiling of selected individuals and groups through the utilization of rule-based, machine learning artificial intelligence to correlate “social profiles” and preferred entertainment venues with extensive available databases, comprising:
a software, firmware, hardware and combinations thereof user's social adhesion database, for creating a highly personalized database that comprises sensory driven psychological traits which define social adhesion including but not limited to likes, dislikes, social compromises within groups as well as group interactive behavior patterns and trends;
a software, firmware, hardware and combinations thereof leisure and entertainment database, for providing a database which details characteristics of leisure and entertainment products and services in a manner that can be correlated with the psychological social adhesion profiles behaviors of selected individual and groups of individuals;
a software, firmware, hardware and combinations thereof user's request for social adhesion match including social event recommendations, for enabling a user to describe a social adhesion event without specifying where and how this product and or service can be acquired;
a software, firmware, hardware and combinations thereof rule-based artificial intelligence recommendation engine, for correlating a user's psychological social adhesion profile and requests for social adhesion event recommendations with available products and services utilizing rule-based correlation techniques such as, but not limited to case-based reasoning, fuzzy models, Inference engine and semantic reasoner approaches;
software, firmware, hardware and combinations thereof data mining technologies for targeting data that can be correlated with user's social adhesion profiles, available leisure and entertainment products and services and user requests for social adhesion event recommendations; utilizing techniques such as, but not limited to tracking patterns, classification, association, outlier detection and clustering; and
a software hardware and combinations thereof secure interactive communications module, for enabling highly secure communication interactions such as, but not limited to audiovisual and text data streams between, but not limited to, multiple users and participants over communications networks such as, but not limited to, internet, cellular, and internal hardwired and/or wireless networks.
